(19) United States
(12) Patent Application Publication
(10) Pub. No.: US 2017/0187726 A1
(43) Pub. Date: Jun. 29, 2017

(54) CROSS-DOMAIN MESSAGE AUTHENTICATION

(71) Applicant: Zeta (Better World Technology Pvt. Ltd.), Mumbai Maharastra (IN)

(72) Inventors: Bhavin Turakhia, Mumbai Maharastra (IN); Ramki Gadipatti, Mumbai Maharastra (IN)

(21) Appl. No.: 15/041,741

(22) Filed: Feb. 11, 2016

(30) Foreign Application Priority Data
Dec. 24, 2015 (IN) 4844/MUM/2015

(51) Int. Cl. H04L 29/06; H04L 12/58; H04L 29/08

(52) U.S. Cl. CPC H04L 63/123; H04L 67/10; H04L 51/36; H04L 63/0876

(57) ABSTRACT

In example embodiments, a system and method performs cross-domain message authentication. Accordingly, a first message is received from a first domain comprising a value, a first user identification of a first user of the first domain, and a second user identification of a second user of the first domain. A second message is received from a second domain. The second message is transmitted from a second domain device associated with the second user. The second message is verified by matching one or more elements of the first message to the second message. Based on the verification of the second message, a value is transmitted to an intermediary server on the second domain.

### CROSS-REFERENCE TO RELATED APPLICATION

This application claims benefit to Indian Patent Application No. 4844/MUM/2015 filed on 24 Dec. 2015 entitled “Payor Authorized External Collection” which is incorporated herein by reference in its entirety.

### FIELD

The present disclosure relates generally to electronic communications, and in a specific example embodiment, to cross-domain message authentication with a system.

### BACKGROUND

Typically, when two entities engage in a transaction, a first entity transmits a value to a second entity. The second entity receives the transmitted value without further interaction by the first entity. The transmission of value indicates completion of the transaction. Affirmation of the transaction by the first user is assumed based on the initiation of the cross-domain transaction by the first entity.

### BRIEF DESCRIPTION OF DRAWINGS

Various ones of the appended drawings merely illustrate example embodiments of the present inventive concepts and cannot be considered as limiting its scope.

FIG. 1 is a diagram illustrating an example environment in which embodiments of a system for authenticating cross-domain messages may be implemented.

FIG. 2 is a block diagram illustrating an example embodiment of a client device.

FIG. 3 is a block diagram illustrating an example embodiment of a control server system.

FIG. 4 is a flow diagram of an example method for cross-domain message authentication.

FIG. 5 is a flow diagram of an example method for cross-domain message authentication.

FIG. 6 is a flow diagram of an example method for cross-domain message authentication.

FIG. 7 is a flow diagram of an example method for cross-domain message authentication.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Example embodiments described herein provide systems and methods for cross-domain message authentication to reconcile a first message sent by a first user via a first domain to a control server with a second message sent by a second user via a second domain to the control server. A control server system receives a message triggered by an application operating on a user device. The message is associated with a first user and includes an indication or identification of a second user, where both the first user and the second user are members associated with the first domain associated with the control server system.

In one example embodiment, systems and methods herein describe an interaction between two users of a domain in which the control server transfers a value between the users across first and second domains. In these example embodiments, the first user instructs the control server to transfer the value in a first message. The value may be transferred to the first domain prior to the first message instructing the transfer of the value. The first message causes the control server to initiate a transfer of the value to the second user. The transfer initiated by the first message should be understood as a first transfer within the first domain. Although the transfer to the second user is initiated, the value maybe held by the control server until released by a second message which indicates a release of the value by the first user. The first user may enable the control server to release the value to the second user based on a second message sent to the control server through a second domain. Alternatively in another embodiment the value maybe released by the control server upon receipt of the first message. The release of the value, by the first user, between the first domain and the second domain should be understood as a second transfer. The second message, sent over the second domain, may originate from a device associated with the second user. In some instances, the second message includes an identification token associated with the second user.

Accordingly, one or more of the methodologies discussed herein may obviate a need for the first user in a value transfer between a first domain and a second domain to interact directly with devices associated with the second domain. The first user, associated with the first domain, initiates the value transfer by a first message to a control server in the first domain. The second user, associated with both the first domain and the second domain, interacts with the second domain to complete the value transfer transmitting a second message using a user device associated with the second domain. This second message is authenticated by the control server in the first domain. This may have the technical effect of reducing computing resources used by one or more devices in the second domain. Examples of such computing resources include, without limitation, processor cycles, network traffic, memory usage, storage space, and power consumption. The systems and methods described herein may also have the technical effect of reducing the generation, tracking, and proliferation of security tokens (e.g., identification tokens) associated with the second domain, enabling more effective and secure use of security tokens within the second domain. Additionally this has the benefit of the second user being able to leverage existing investments of devices associated with the second domain to participate in transfer of value in the first domain.

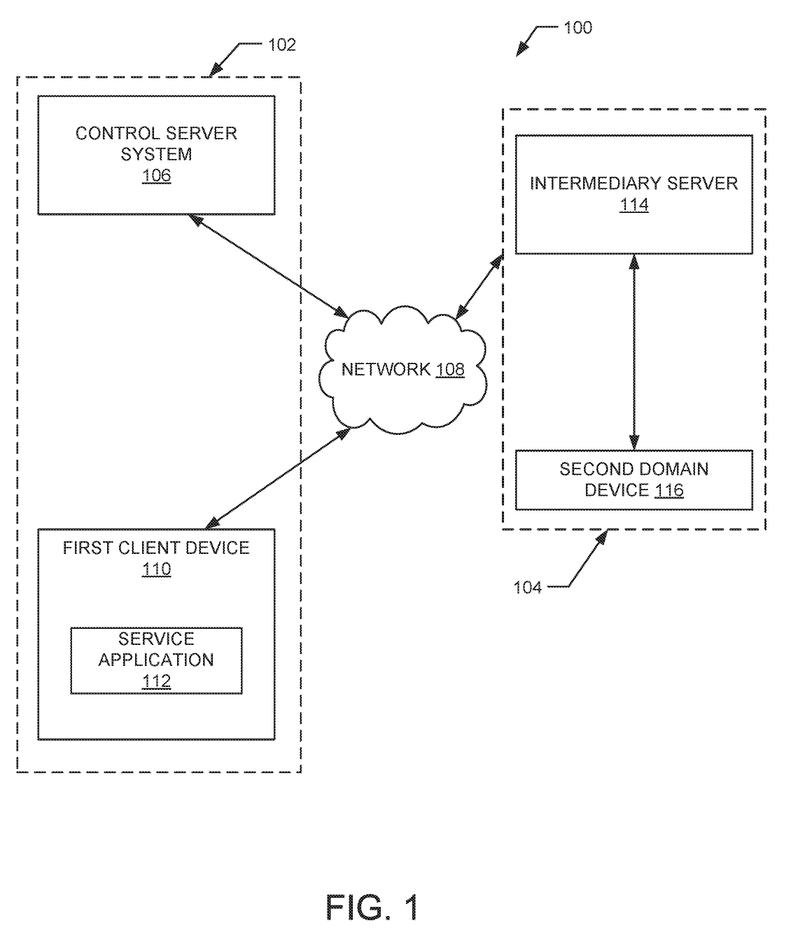

With reference to FIG. 1, a diagram illustrating an example environment 100 in which embodiments of a system for cross-domain message authentication is shown. The environment 100 comprises a first domain 102 and a second domain 104. The first domain 102 contains a control server system 106 coupled via a network 108 (e.g., the Internet, wireless network, cellular network, or a Wide Area Network (WAN)) to a plurality of user devices. As shown in FIG. 1, the plurality of user devices are represented by a first client device 110, shown as a portion of the first domain 102 and including a service application 112. The second domain 104 contains an intermediary server 114 and a second domain device 116.

Each client device 110 is associated with a user (e.g., a first user associated with the first client device 110 where the user is a member of or otherwise associated with the first domain 102) that has downloaded or otherwise installed a service application 112 onto their respective client device 110. The client device 110 may comprise a mobile phone, laptop, tablet, or any other communication device that a user may utilize to store, access, or operate the service application 112.

The service application 112 comprises a piece of functionality on the client device 110 that generates messages enabling the control server system 106 to perform functions or operations controlling the function of one or more third party systems (e.g., the intermediary server 114 and the second domain device 116). To that end, the control server system 106 may provide the service application 112 to the first client device 110 (e.g., provide a downloadable version of the service application 112, electronically send the service application 112 to the first client device 110, physically send to the first user via a storage medium such as a CD ROM).

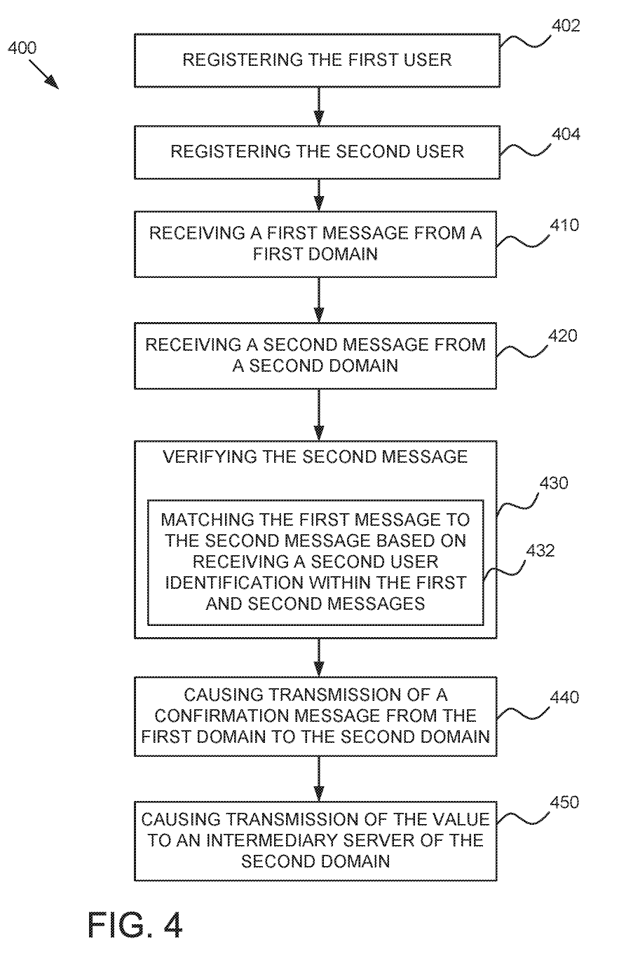

Once the service application 112 is installed on the first client device 110, the service application 112 may automatically verify a user identification corresponding to the first user associated with the first client device 110 (e.g., mobile number, e-mail address, phone number) and authenticate the first client device 110 and/or the user with the control server system 106. The authentication process may occur in the background of the first client device 110 without any user intervention. The first user may not even be aware that the authentication process is occurring. In example embodiments, the verification of the first user and the first client device 110 may comprise, in part, a registration process to register the first user with the control server and the first domain 102. The authentication process will be discussed in more detail in connection with FIG. 4 below.

In various example embodiments, the intermediary server 114 is configured to communicate with one or more component of the first domain 102. In some embodiments, the first domain 102 and the second domain 104 may be a closed payment network such as a credit card network, a loyalty points network, a banking network, or a payment services network. In these embodiments, the intermediary server 114 may be a server of the second domain 114 configured to transmit and receive payment communications between the first domain 102 and the second domain 104, for users associated with the second domain 104. The payment communications may include transaction communications claiming or otherwise accepting payment for a good or service, value transfers (e.g., receiving a value transmitted from the first domain 102 to the second domain 104 for disposition by the second domain 104). In various example embodiments, the intermediary server 114 handles communications between the second domain device 116 and the control server system 106 which have no direct communication links.

The second domain device 116 is a device associated with the second domain 104. In some embodiments, the second domain device 116 is a device capable of communication with the intermediary server 114 using a predefined message format. The second domain device 116 may be a credit card reader, a point of sale system, or any other suitable device configured to communicate with the closed network of the second domain 104 and with the intermediary server 114. The second domain device 116 may generate messages for transmission to the intermediary server 114, which may, in turn, transmit the messages to the control server system 106. In some embodiments, the second domain device 116 may receive confirmation messages from the control server system 106 via the intermediary server 114.

It is noted that the environment 100 shown in FIG. 1 is exemplary. Alternative example embodiments may comprise any number of control server systems 106 and client device 110 in communication in the environment 100.

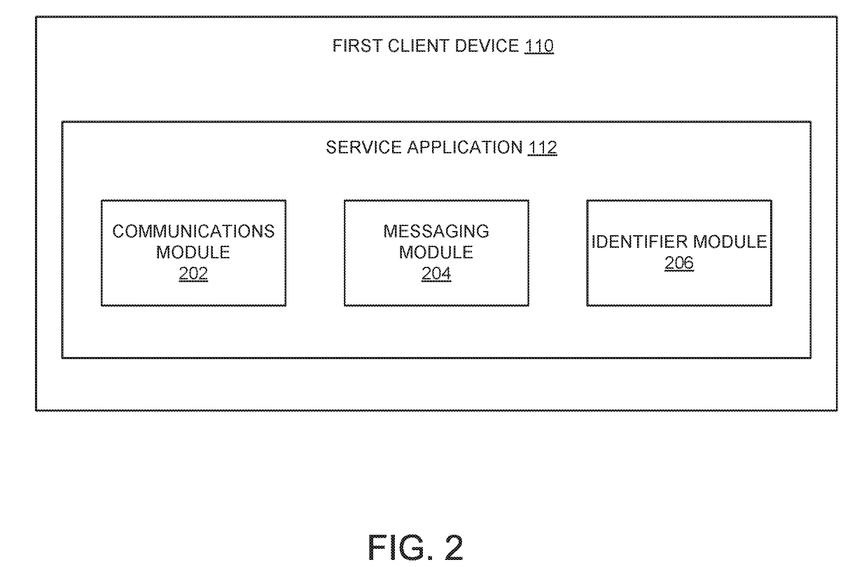

Referring now to FIG. 2, a block diagram illustrating an example embodiment of the first client device 110 is shown. The first client device 110 is shown having the service application 112 installed thereon. The service application 112 provides functionality and services to the first client device 110 that may be provided to and from the control server system 106. To enable the functionality on the first client device 110, the service application 112 may comprise a communications module 202, a messaging module 204, and an identifier module 206. It is noted that the service application 112 may comprise other modules not pertinent to example embodiments that are not shown or discussed.

The communications module 202 manages communications with the control server system 106. Upon installation, the communications module 202 may exchange communications with the control server system 106 to perform the verification and authentication (e.g., registration) of the first user and the first client device 110 with the control server system 106 and the first domain 102. In example embodiments, the communications module 202 may take over control of one or more communication capabilities of the first client device 110. In some instances, the communications module 202 takes control of one or more of the SMS messaging capabilities, the WiFi communication capabilities, and the cellular communication capabilities of the first client device 110 to exchange the communications with the control server system 106. The communications module 202 may determine a communication address for the control server system 106. The communication address may be a service number (e.g., phone number) or an address within the first domain 102. For example the address may be an Internet Protocol (IP) address, a domain name, or a uniform resource identifier (URI) for the control server system 106. The URI may be a uniform resource locator (URL) or a uniform resource name (URN). The communications module 202 uses the communication address to send a registration message to the control server system 106. In example embodiments, the communication address may be fetched by the communications module 202 from the control server system 106. Alternatively, the communication address may be hardcoded into the service application 112. The communications module 202 also receives reply messages from the control server system 106.

In various example embodiments, the messaging module 204 generates one or more registration messages for transmission to the control server system 106 by the communications module 202. The one or more registration messages may establish an account of the first user with the control server system 106 and verify the identity of the first user. In example embodiments, as will be described in more detail below with respect to FIG. 4, the one or more registration messages include one or more of identification, demographic, and location information transmitted to the control server system 106 by the communications module 202. In example embodiments, one of the reply messages includes a token or other verification code from the control server system 106. The messaging module 204 extracts the token from the reply message. The token may then be returned to the control server system 106 to validate a second message sent from a second domain 104 to the control server system 106.

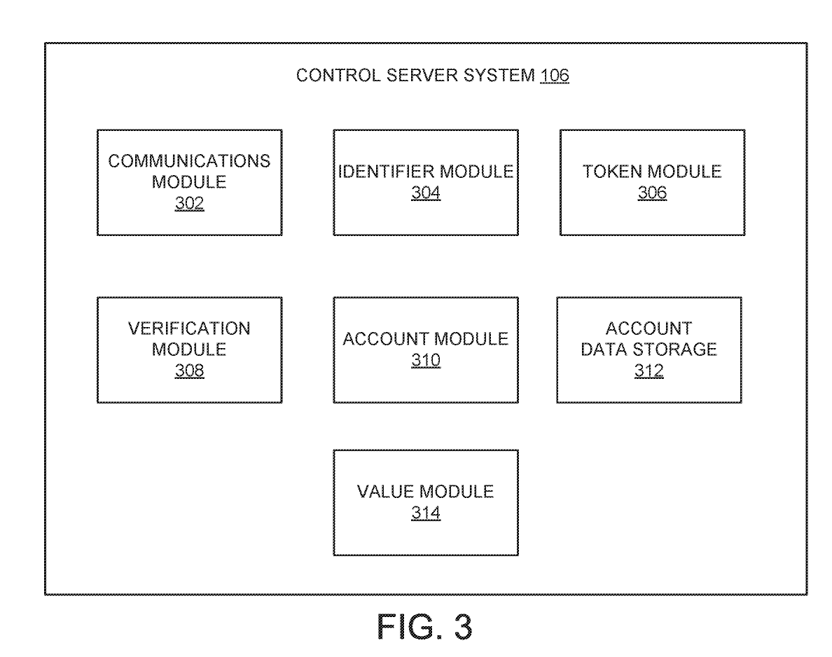

Referring now to FIG. 3, the control server system 106 is shown in more detail. In example embodiments, the control server system 106 comprises one or more servers that provide functionality and services to the service applications 112 running on the first client device 110. Prior to allowing the service application 112 to access content or functionalities with the control server system 106, the contact identifier (e.g., user identification) corresponding to the first client device 110 is verified as belonging to one or more of the first client device 110 and the first user. Validating the user identification authenticates the first client device 110 and the first user as associated with the first domain 102 and the control server system 106. In example embodiments, the control server system 106 uses the user identification (e.g., mobile number) corresponding to the first client device 110 or the first user as an authentication vector. Accordingly, the control server system 106 may comprise a communications module 302, an identifier module 304, a token module 306, a verification module 308, an account module 310, and a value module 314. Alternative example embodiments may comprise more, less, or other modules for cross-domain communication and message authentication. Some functions of the modules may be combined or divided into two or more further modules.

The communications module 302 manages communications with the first client devices 110 and client devices associated with the second domain 104. Accordingly, the communications module 302 may receive messages transmitted according to communications capabilities of devices associated with each of the first domain 102 and the second domain 104. In example embodiments, a message may comprise SMS messages, web requests from the first client device 110, audio/telephony messages (e.g. recorded messages or duplex audio transmissions), or any other suitable communications method. The communications module 302 may also provide reply messages to one or more of the first client device 110 and one or more devices associated with the second domain 104 (e.g., the second domain device 116).

The identifier module 304 determines a user identification corresponding to one or more of the first user or the first client device 110. In example embodiments, when a first message is received from the service application 112 of the first client device 110, the identifier module 304 may extract the identifying information from the message. In example embodiments, the identifier module 304 extracts a first user identification associated with the first user and a second user identification associated with the second user. The user identification corresponding to the first client device 110 and devices associated with one or more users associated with the first domain 102 and the second domain 104 (e.g., the second domain device 116) may be stored in the control server system 106 (e.g., in an account data storage) and used to provide reply messages to the first client device 110 and validating a second message based on one or more elements contained in the first message. In some instances, the first user identification and the second user identification are among the one or more elements used to validate the second message.

In example embodiments, the token module 306 selects a confirmation code to provide to the first client device 110 for the authentication process of the second message. For example, the token module 306 may generate the confirmation code, store the confirmation code in association with one or more of the first message, the first user identification, the second user identification, and a value included within the first message. The token module 306 provides the confirmation code to the communications module 302 to be returned to the first client device 110 in a reply message. In some instances, the reply message may be an SMS message, a user interface element generated within the service application, an email, an audio/telephony message (e.g., a recorded audio/telephony message or a duplex audio communication), or any other suitable message.

In various example embodiments, the token module 306 generates an identification token for the second user associated with the first domain 102. The identification token is associated with the second user by the control server system 106 and recognized by the control server system 106 upon receipt in the second message. The identification token may be generated based on one or more generation rules of the second domain 104. In some instances, the identification token is generated from a predetermined range (e.g., a range of numerical characters or alpha-numeric characters) established by the second domain 104. The identification token may be a security token, a hardware token, a software token, a physical device encoded with a unique code, or any other suitable identification token. In some instances, the identification token is encoded into one or more of a magnetic stripe, a radio-frequency identification chip, or an integrated circuit card, a card number (e.g., a card number printed on or embossed on a card), or any other suitable manner of incorporating the identification token into a physical card or device readable by a device (e.g., a credit card reader, a mobile device connected card reader, or a point of sale system) associated with the second domain 104.

The verification module 308 verifies one or more of a returned confirmation code (e.g., the confirmation code transmitted in response to the first message and returned within the second message) and the identification token included in the second message. The second message may be received from a second device of the second domain 104 associated with the second user. For example, the service application 112 at the first client device 110 may intercept the reply message including the confirmation code and extract the confirmation code in the reply all without user intervention. The confirmation code may then be returned to the control server system 106 in a second message transmitted from a device of the second domain 104 to authenticate the second message by comparing the second message with one or more of the first message and the confirmation code in the reply transmitted to the first client device 110. In one embodiment the confirmation code is provided by the first user to the second user so that the second user may input the same in the second domain device 116 and send it as a part of the second message. In one example embodiment, the confirmation code is returned via a web request. In alternative example embodiments, other forms of communications may be used to return the confirmation code (e.g., SMS messaging). The verification module 308 compares the returned confirmation code to a record of the confirmation code that was sent to the first client device 110. Based on the returned confirmation code matching the stored confirmation code, the verification module 308 verifies the first message as mapping to the second message.

In example embodiments, the verification module 308 verifies the second message by mapping one or more elements of the second message to the first message. The mapping operations may be matching values, tokens, identifiers, or other data contained within the first message and the second message. In some example embodiments, the verification module 308 matches one or more of a value, the second user identification, the confirmation code, and the identification token contained in the second message with elements of the first message. In some instances, the verification module 308 interprets elements delivered in differing communication types. The verification module 308 may translate or otherwise interpret elements contained in audio/telephony messages, text-based messages (e.g., SMS messages), web-based messages, touch-tone messages, or any other suitable message format capable of being received by the control server system 106 from a device associated with the second domain 104 and conveying the one or more elements of the second message. In some instances, the verification module 308 verifies the second message based on a time elapsed between receiving the first message and receiving the second message, an order of receiving messages with a device of the second domain 104 associated with the second user, or based on a difference between an expected second message and an actual second message, as will be explained below in more detail.

Once authenticated, the account module 310 may determine whether the first user identification and the second user identification are registered with the control server system 106. Accordingly, the account module 310 may perform a lookup in the account data storage 312. If the user identifications are already registered, then an account may already exist for the first user/first client device 110 and the second user and the control server system 106 may perform one or more value transfer operations in response to the first message and/or the second message. The account module 310 may determine whether the second user identification is registered with the control server system 106 based on receiving the second message including one or more of the second user identification and the identification token. In response to determining the registration of the second user and validating the second message, the account module 310 in cooperation with the value module 314 may finalize the value transfer operations initiated in response to the first message and/or confirm the successful transfer initiated based on the first message in a response to the second message.

The value module 314 performs one or more operations associated with verifying a value included in the first message and associated with the account of the first user, and transferring the value to the account of the second user. In some instances, the value module 314 transfers the value to an intermediary server of the second domain 104 for processing and disposition by one or more device of the second domain 104. In some instances, the value module 314 cooperates with the communications module 302 to transfer the value to the intermediary server.

FIG. 4 is a flow diagram of an example method 400 for cross-domain message authentication and authentication of the first client device 110. The operations of the method 400 may be performed by the control server system 106 which may be embodied on one or more servers.

In example embodiments, prior to initiating the method 400, the account module 310 of the control server system 106 performs one or more registration and initialization operations. As shown in FIG. 4, the registration and initialization operations may include operations 402 and 404. In operation 402, the control server system 106 registers the first user with the control server system 106 and the first domain 102. The control server system 106 receives a registration request and first user information. In response to receiving the request and the first user information, the control server system 106 generates a first account for the first user within the first domain and associates the first user information with the first account. In example embodiments, the user information includes biographical information such as a name, date of birth, an address (e.g., a billing address or a shipping address), and a payment account. The payment account may be a bank account, a payment services account (e.g., a third party payment account), or any other account capable of storing a value associated with the first user and transferring at least a portion of the value to the first account associated with the first user within the second domain 104.

In operation 404, the account module 310 of the control server system 106 registers the second user with the control server system 106 and the first domain 102. In example embodiments, the control server system 106 receives a registration request and second user information for the second user. In response to receiving the request and the second user information, the control server system 106 generates a second user account for the second user within the first domain 102 and associates the second user information with a second account. The user information may include biographical information, a date of birth, an address, and a payment account, as described above. In some instances, where the second user is a vendor or associated with a vendor, the control server system 106 may generate a identification token for the second user, as described below.

In operation 410, the communications module 302 of the control server system 106 in the first domain 102 receives a first message from the first client device 110. The first message has one or more elements. In example embodiments, the first message comprises a value associated with a first user, a first user identification, and a second user identification. The first user identification is an identification of the first user of the first domain 102. The first user identification may be included as a plurality of first user identifications, such as differing user identifications or the first user identification in multiple parts of the message (e.g., the header and the body). The second user identification is an identification of the second user of the first domain 102. The second user identification may be included as a plurality of second user identifications, such as multiple user identifications associated with a single user or a single second user identification stored in differing parts of the first message. In some instances, the value may be a plurality of distinct values. The value may be any stored value such as an alphanumeric value (e.g., a message, a coupon code, or a promotional redemption code), a monetary value, reward points, loyalty points, a cash-back value, a merchant specific currency, a crypto-currency, or any other value to be transferred between the first user and the second user. The first message may be a value transfer message configured to cause the control server system 106 to identify the value within the first user account and transfer the value to the second user account identified by the second user identification within the first message. For example, the first message may be an indication of payment from the first user to the second user for goods or services to be purchased by the first user from the second user. The control server system 106 may transfer the value based on receiving the first message, but prevent release of the value from the second account until a second message is received which originates from the second user.

In example embodiments, the first message is generated through a user interface presented at the first client device 110. The user interface may be generated by the service application 112 and configured to generate the first message using a series of selections of user interface elements within the user interface. The first message may be generated by selecting a user interface element representing a transfer. The first client device 110 may receive the second user identification through a selection received at the user interface. In example embodiments, the first client device 110 presents a list of users associated with the first domain 102. The first client device 110 receives the second user identification based on selection of a user identification from the list of users presented on the user interface. After receiving the selection of the second user identification, the user interface may present a data entry field to receive the value of the first message. The service application 112 may generate the first message based on the selected second user identification, the value received through the data entry field, and the first user identification, received when the first user opens the service application 112 and logs in with the first user identification associated with the first user account. Once the first message is generated, the first client device 110 may transmit the first message to the control server system 106.

In operation 420, the communications module 302 of the control server system 106 receives a second message from a second domain 104. The second domain 104 may be a closed payment network such as a credit card network, a loyalty points network, a banking network, or a payment services network. In example embodiments, the second message is transmitted from a second domain device 116 associated with the second user. The second domain device 116 may be a device which operates within the second domain 104 such as a credit card reader, a point of sale system, a cash register, or any other device capable of receiving or transferring values within the second domain 104. The second domain device 116 may have no direct connection to the first domain 102, but communicate with the first domain 102 through one or more servers (e.g., the intermediary server) of the second domain 104. The second domain device 116 may generate and transmit the second message based on interaction with the second domain device 116 by the second user.

The second domain device 116 may receive input from the second user to generate the second message. The second message comprises one or more elements. As shown in FIG. 4, in some instances the second message may include the second user identification. In example embodiments, the second message includes the value received in the first message. For example, where the first message is generated to transfer the value from the first user to the second user to purchase goods or services, the second message may include the value from the first message, initiating the transaction, and be generated by a point of sale system or a credit card reader prior to the transfer of goods or after completion of the services purchased by the first user. In example embodiments, the second message contains a time value indicating a time at which the second message was generated or transmitted. After generation of the second message, the second domain device 116 may transmit the second message to the control server system 106 within the first domain 102. In some instances, the second domain device 116 transmits the second message to an intermediary server, configured to process value transfers between the first domain 102 and the second domain 104. The intermediary server may then transmit the second message to the control server system 106 of the first domain 102.

In operation 430, the verification module 308 of the control server system 106 verifies the second message. In example embodiments, the second message is verified by mapping the first message to the second message. Mapping the first message to the second message may be performed by matching one or more elements of the first message to the second message. The second message may be mapped to the first message where the second message comprises a subset of the one or more elements of the first message. Verification of the second message may release the value within the second account to be transferred out of the first domain 102 to the second domain 104.

In example embodiments, where the second message includes the time value, indicating a time of generation or transmission, the control server system 106 may validate the second message based in part on the time value. The control server system 106 may prevent completion of the transaction initiated by the first message where the control server system 106 receives an intervening message prior to receiving the second message. In these instances, the control server system 106 verifies the second message by determining whether the control server system 106 has received an intervening message from the second domain device 116 associated with the second user after receiving the first message and prior to receiving the second message. Where the control server system 106 determines no intervening message has been received, the control server system 106 verifies the second message by matching one or more element of the second message and one or more element of the first message. Where the control server system 106 determines an intervening message has been received, the control server system 106 identifies whether the intervening message completed the transaction. Where the intervening message completed the transaction, the control server system 106 discards the second message. Where the intervening message did not complete the transaction initiated by the first message, the control server system 106 terminates the transaction initiated by the first message.

As shown in FIG. 4, in some instances, as part of operation 430, the control server system 106 performs operation 432. In operation 432, the identifier module 304 of the control server system 106 matches the first message to the second message based on receiving the second user identification within the second message. For example where the first message comprises the first user identification, the second user identification, and the value, the second message maps to the first message where the second message comprises at least the second user identification.

In operation 440, in response to verifying the second message, the control server system 106 generates a confirmation message. The confirmation message may include a completion indicator, indicating the transaction initiated by the first message has been completed by the second message. After being generated, the confirmation message is transmitted from the first domain 102 to the second domain 104. In some embodiments, the confirmation message is transmitted from the control server system 106 to the intermediary server 114 via the network 108. In some instances, the confirmation message is routed through the intermediary server to the second domain device 116. Although shown in FIG. 4 as confirming the verification of the second message, in some embodiments, the confirmation message may confirm the transfer of the value from the first domain to the second domain.

In operation 450, the communications module 302 of the control server system 106 causes transmission of the value on the control server system 106 to an intermediary server of the second domain 104. The transmission may be based on the verification of the second message, and may be performed in response to the control server validating the second message. Transmission of the value from the control server system 106 to the intermediary server, in the operation 450, passes the value out of the first domain 102 and to the second domain 104. For example, the transmission in the operation 450 may transfer a monetary value from the second user account in the first domain 102 to the intermediary server. Once transferred to the intermediary server, the value may be deposited in a user account within the second domain 104 associated with the second user. In example embodiments, the value is transferred by the intermediary server to an account in a payee bank associated with the second user.

Although in some example embodiments, as depicted in FIG. 4, the value is transmitted from the first domain 102 to the second domain 104 in the operation 450. In some embodiments, verification of the second message completes the transaction initiated by the first message and causes the control server system 106 to release the value transferred into the second account from the first account without transferring the value outside of the first domain 102. For example, where the value comprises loyalty points or rewards points, transferring the value from the first account to the second account may return to or redeem the loyalty points or reward points with a vendor administering the loyalty or rewards points.

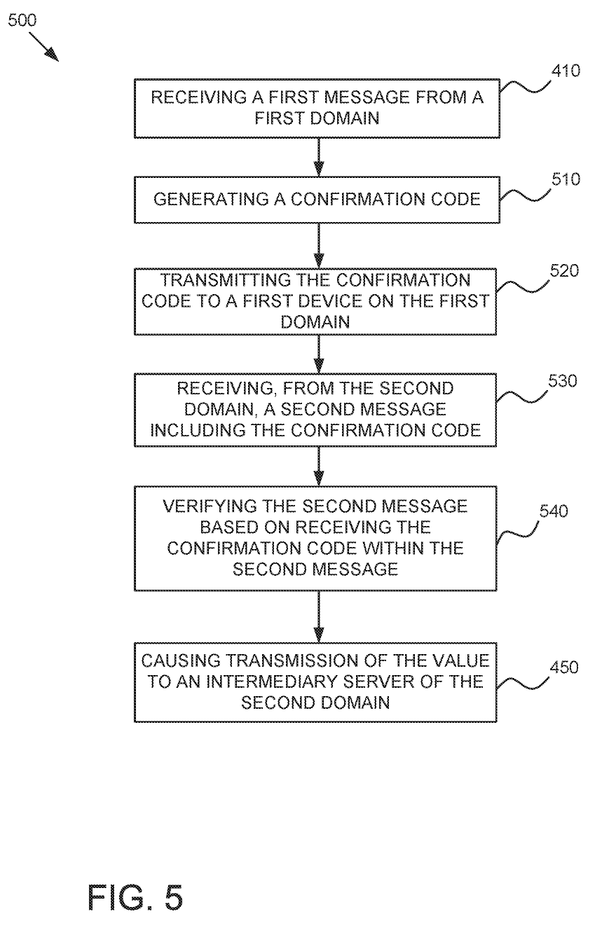

FIG. 5 is a flow diagram of an example method 500 for cross-domain message authentication. In example embodiments, operations of the method 500 are performed as one or more sub-operations of one or more operations of the method 400. In example embodiments, the method 500 is initiated by the control server system 106 performing the operation 410.

In operation 510, in response to the first message, the token module 306 of the control server system 106 generates a confirmation code. In example embodiments, the confirmation code identifies a transaction initiated by the first message. The confirmation code is a numeric code, an alphanumeric code, or any other suitable confirmation code. In some instances, the confirmation code is a six digit number, unique for the transaction. After generation, the confirmation code may be stored within the control server system 106 along with the first message to identify the transaction initiated by the first message.

In example embodiments, the confirmation code includes a predetermined time duration. The predetermined time duration is a time during which the transaction is active. The predetermined time duration may be stored within the control server system 106 along with the confirmation code and the first message identifying the transaction. Receipt and verification of the second message within the predetermined time duration causes the control server system 106 to complete the transaction. Where the control server system 106 fails to receive the second message within the predetermined time duration, the control server system 106 transfers the value included within the first message back into the first user account. In example embodiments where the confirmation code identifies a transaction, the control server system 106 generates a unique confirmation code for the transaction. In example embodiments, the confirmation code is determined to be unique from a set of confirmation codes for transaction that are currently pending (e.g., transactions which have not yet been completed) within the control server system 106.

In operation 520, the communications module 302 of the control server system 106 transmits the confirmation code to the first client device 110. In response to receiving the first message, in the operation 410, and generating the confirmation code, in the operation 520, the control server system 106 transmits the confirmation code to the first client device 110. The confirmation code may be transmitted and displayed within the service application 112, within an SMS message, within an email, or any other suitable message.

After the confirmation code is transmitted to the first client device 110, the second user receives the confirmation code from the first user. In example embodiments, the first user may verbally transfer the confirmation code to the second user. The first client device 110 or the service application 112 operating on the first client device 110 may transfer the confirmation code to the communications device of the second user or the second domain device 116. For example, the first client device 110 may transfer the confirmation code to one or more of the communications device and the second domain device 116 by SMS message, email, short range communications (e.g., near field communication (NFC), Bluetooth, Bluetooth Low Energy), or any other suitable communication method.

In operation 530, the communications module 302 receives, from the second domain 104, the confirmation code included within the second message. In some instances, the confirmation code is entered into the second domain device 116 during generation of the second message. The confirmation code may be entered into the second domain device 116 as a pin number to identify the second message as a part of the transaction initiated by the first message. In example embodiments, the confirmation code may be entered to initiate generation of the second message prior to entering the one or more elements comprising the second message.

In operation 540, the verification module 308 matches the first message to the second message based on receiving the confirmation code within the second message. To match the confirmation code received with the second message, the control server system 106 identifies the confirmation code for the transaction, stored with the first message and transmitted in response thereto. The control server system 106 identifies the confirmation code received within the second message and compares the stored confirmation code with the received confirmation code. Upon comparing the stored confirmation code and the received confirmation code and identifying a match, the control server system 106 verifies the second message and performs the operation 450. In example embodiments, in addition to transmitting the value, the control server system 106 stores the second message with the first message and the confirmation code, completing the transaction initiated by the first message.

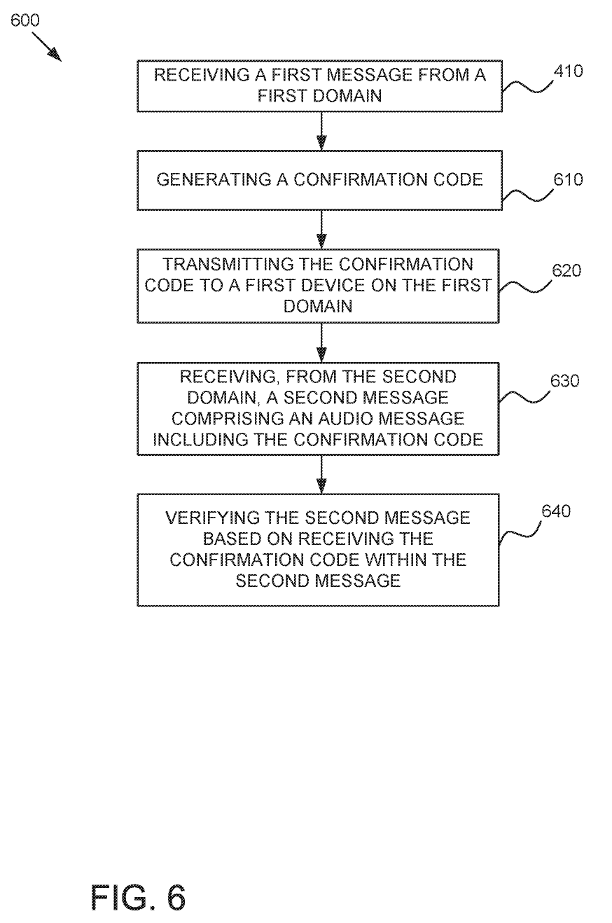

FIG. 6 is a flow diagram of an example method 600 for cross-domain message authentication. In example embodiments, operations of the method 600 are performed as one or more sub-operations of one or more operations of the method 400. In example embodiments, the method 600 is initiated by the control server system 106 performing the operation 410.

In operation 610, in response to the first message, the token module 306 of the control server system 106 generates a confirmation code. The control server system 106 may generate the confirmation code in a manner similarly to or the same as the operation 510, described above with respect to FIG. 5. The confirmation code may be unique with respect to the transactions currently pending on the control server system 106 or may be unique with respect to the pending and completed transaction on the control server system 106.

In operation 620, the communications module 302 of the control server system 106 transmits the confirmation code to the first client device 110. The control server system 106 may transmit the confirmation code in a manner similar to or the same as the operation 520, described above with respect to FIG. 5.

In operation 630, the communications module 302 receives the second message comprising an audio/telephony message including the confirmation code. In some instances, the audio/telephony message is transmitted to the control server system 106 from a communications device over a communications network. The communications network may be associated with a domain separate from the first domain 102 and the second domain 104. In example embodiments, the audio/telephony message is a full duplex voice communication (e.g., a telephone call, a voice over Internet Protocol (VoIP) transmission, or a video call) and the communications network is a telephone, wireless, a public switched telephone network, a private branch exchange, or any other suitable communications network. For example, after the control server system 106 transmits the confirmation code to the first client device 110, in the operation 620, the first user provides the confirmation code to the second user. The second user, after receiving the confirmation code, places a call on the communication device (e.g., a telephone), using the communications network, to a telephone number associated with the control server system 106. The second user verbally provides the second message, including the confirmation code, to the control server system 106 during the telephone call.

In some instances, the audio/telephony message may be recorded and transmitted to the control server system 106 after being recorded. In these example embodiments, the second user, after receiving the confirmation code from the first user, may initiate a voice recording on the communications device. The communications device transmits the voice recording to the control server system 106 by email, SMS message, or any other suitable transmission method.

In operation 640, the verification module 308 matches the first message to the second message based on receiving the confirmation code within the second message. The control server system 106 identifies the confirmation code transmitted within the audio/telephony message and identifies a stored confirmation code for the first message initiating the transaction. The control server system 106 compares the stored confirmation code with the confirmation code received in the audio/telephony message. Where the stored confirmation code and the received confirmation code match, the control server system 106 finalizes transmission of the value from the first user account, associated with the first user, to the second user account, associated with the second user. In some embodiments, the transfer of the value from the first account to the second account may be performed automatically in response to validation or verification of the second message. In other embodiments the transfer may take place on receipt of the first message and a confirmation sent back to the second user in response to the second message.

In some instances, transfer of the value from the first account to the second account may cause the communications module 302 to transmit the value from the first domain 102 to the second domain 104. In these embodiments, the communications module 302 may transmit the value to the intermediary server 114. The transmission of the value may contain a second domain account designation for the second user to cause the intermediary server 114 to store the value, or dispose of the value, in the second account. For example, the second domain account may a bank account or credit card account associated with the second user based on inclusion in the second account on the first domain 102. In response to transferring the value to the second account on the first domain 102, the control server system 106 may transfer the value to the bank account or credit card account of the second user within the second domain 104.

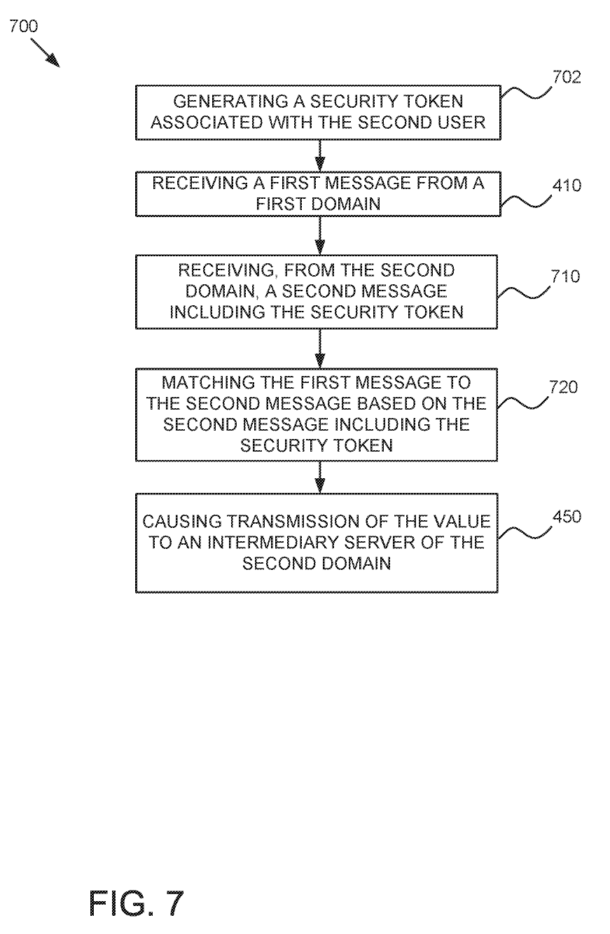

FIG. 7 is a flow diagram of an example method 700 for cross-domain message authentication. In example embodiments, operations of the method 700 are performed as one or more sub-operations of one or more operations of the method 400.

In operation 702, prior to initiation of the method 700 and in response to registering the second user as a vendor or in association with a vendor in the operation 404, the token module 306 of the control server system 106 generates a identification token associated with the second user. The identification token identifies the second user within the second domain 104. In some instances, the identification token identifies the second user within the first domain 102. The identification token is configured to cause the second domain device 116 to generate the second message. The identification token may be a number, code, or other identifier to be associated with the second user. In example embodiments, the control server system 106 generates the security code in cooperation with a second domain 104. In these instances, the identification token may be generated from a identification token range established by the second domain 104. For example, the second domain 104 may provide the control server system 106 of the first domain 102 with a numerical range between which identification tokens are to be generated. The control server system 106 may generate the identification token and store the identification token in the second user account. Where the identification token is generated within a predefined numerical range, provided by the second domain 104 to the first domain 102, identification tokens generated within the numerical range may be associated in the second domain 104 with the control server system 106 of the first domain 102. The association within the second domain 104 causes devices within the second domain 104 to transmit messages to the control server system 106 within the first domain 102 once the identification token is received and identified within the predetermined range.

Once generated, the identification token may be applied to a physical representation of the identification token. In example embodiments, the physical representation of the identification token is a card. The card may be similar in form to a payment card, such as a credit card or debit card. In some instances, the card is associated with the second domain 104 and recognized by devices associated with the second domain 104. For example, where the second domain 104 is a payment domain, such as a credit card network, the card may be issued to the second user as a payment card of the credit card network.

The identification token may be applied to the card by a plurality of methods. The identification token may be printed on the card, embossed into the card, encoded into a magnetic strip, encoded into an integrated circuit and attached or otherwise integrated into the card, encoded into an RFID chip and attached or otherwise integrated into the card, or applied in any other suitable manner. Once the identification token has been applied to the card, the card may be transferred to the second user using the second user information supplied to the first domain 102 by the second user.

In example embodiments, as shown in FIG. 7, the method 700 is initiated by the control server system 106 performing the operation 410. In operation 710, communications module 302 of the control server system 106 receives, from the second domain 104, the identification token of the second user included within the second message. In example embodiments, the identification token replaces the second user identification within the second message. The identification token may be used to initiate generation of the second message by the second domain device 116. For example, where the identification token is embodied as a card with an encoded magnetic strip and the second domain device 116 is a credit card reader, the second domain device 116 may receive the identification token by the card being swiped through a card reading apparatus. Receiving the identification token causes the second domain device 116 to generate the second message. Further, in response to receiving the identification token, the second domain device 116 causes presentation of one or more prompts for data associated with one or more elements to be included in the second message. In example embodiments where the second message includes the value as one of the included elements, the second domain device 116 generates a user interface prompting entry of the value. In instances were the second message includes the confirmation code, as an element generated in the operations 510 or 610, the second domain device 116 generates a user interface prompting entry of the confirmation code for inclusion in the second message.

In operation 720, the account module 310 of the control server system 106 matches the first message to the second message based on the second message including the identification token. Where the control server system 106 matches the identification token, the control server system 106 accesses the second user identification stored in the first message and the identification token received within the second message. The control server system 106 identifies a user account (e.g., the second user account) associated with the identification token. Where the second user identification, received in the first message, matches the user identification associated with the identification token, the control server system 106 verifies the second message.

Where the control server system 106 generates the confirmation code and the second message includes the confirmation code and the identification token, the verification module 308 of the control server system 106 matches the confirmation code received in the second message, similar to the manner described above with regards to the operation 430. In addition to matching the confirmation code, the control server system 106 matches user identification associated with the identification token to the received second user identification.

In example embodiments, in the operation 720, where the second message includes the value and the identification token, the account module 310 of the control server system 106 matches the first message to the second message based on the second message including the identification token. In these instances, the account module 310 determines the second message includes the identification token and the value. As described above, the account module 310 identifies the user identification associated with the identification token and compares the identified user identification with the second user identification stored with the first message. The value module 314 also matches the value received in the second message with the value stored with the first message. In example embodiments, where the value module 314 matches the value included in the first message and the second message, the value module 314 determines the value has been transferred from the first user account to the second user account within the first domain 102. After validating the second message based on the second message including the identification token, the communications module 302 causes transmission of the a generated confirmation message from the first domain 102 to the second domain 104, as described in the operation 440. In some embodiments, where the second domain device 116 is a card reader, the confirmation message may appear as an approval presented on a user interface of the card reader. In response to the validation of the second message, the communications module 302 may also cause transmission of the value to the intermediary server, as described in the operation 450.

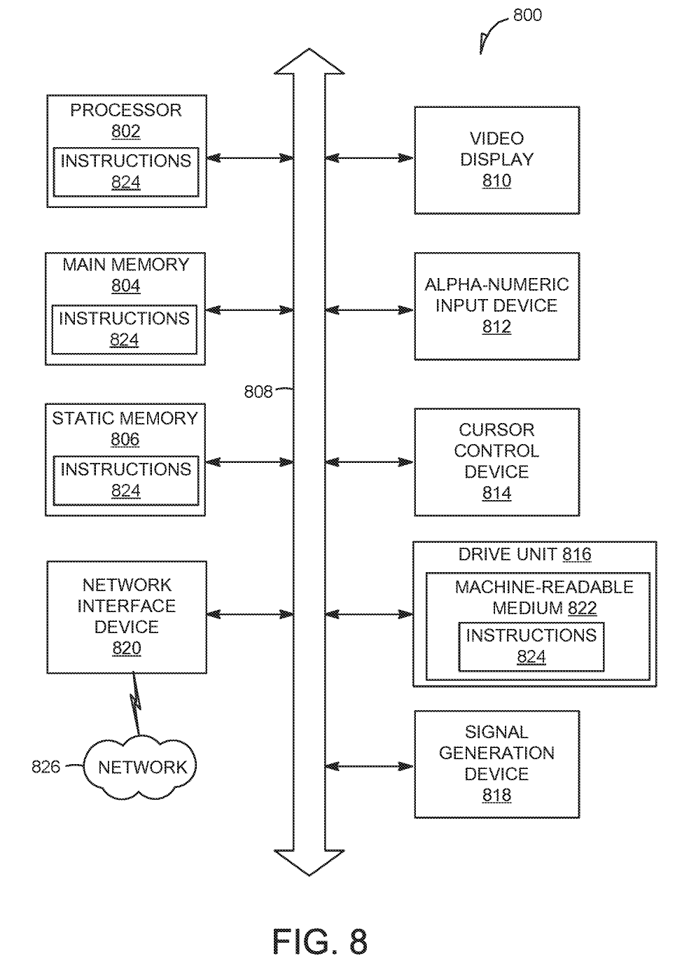

FIG. 8 is a block diagram illustrating components of a machine 800, according to example embodiments, able to read instructions (e.g., processor executable instructions) from a machine-readable medium (e.g., a non-transitory processor-readable storage medium) and perform any one or more of the methodologies discussed herein. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed. In alternative example embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics/video display 810 (e.g., a plasma display panel (PDP), a light emitting diode (LED) display, a liquid crystal display (LCD), a projector, or a cathode ray tube (CRT)). The machine 800 may also include an alpha-numeric input device 812 (e.g., a keyboard), a cursor control device 814 (e.g., a mouse, a touchpad, a trackball, a joystick, a motion sensor, or other pointing instrument), a storage/drive unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the tangible machine-readable medium 822 is shown in an example embodiment to be a single medium, the terms “machine-readable medium” and “processor-readable medium” should be taken to include a single medium or multiple media (e.g., a centralized or distributed database, or associated caches and servers) able to store instructions. The terms “machine-readable medium” and “processor-readable medium” shall also be taken to include any medium, or combination of multiple media, that is capable of storing instructions for execution by a machine (e.g., machine 800), such that the instructions (e.g., instructions 824), when executed by one or more processors of the machine (e.g., processor 802), cause the machine to perform any one or more of the methodologies described herein. Accordingly, a “machine-readable medium” or “processor-readable medium” refers to a single storage apparatus or device, as well as “cloud-based” storage systems or storage networks that include multiple storage apparatus or devices. The terms “machine-readable medium” and “processor-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such example embodiments of the inventive subject matter may be referred to herein, individually or collectively, by the term “invention” merely for convenience and without intending to voluntarily limit the scope of this application to any single invention or inventive concept if more than one is, in fact, disclosed.

The example embodiments illustrated herein are described in sufficient detail to enable those skilled in the art to practice the teachings disclosed. Other example embodiments may be used and derived therefrom, such that structural and logical substitutions and changes may be made without departing from the scope of this disclosure. The Detailed Description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various example embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of example embodiments of the present invention as represented by the appended claims. The specification and drawings are, accordingly, to be regarded in an illustrative rather than a restrictive sense.

What is claimed is:

1. A method comprising:
receiving, at a control server in a first domain, a first message from a first device, the first message comprising: a value associated with a first user, a first user identification of the first user associated with the first domain, and a second user identification of a second user associated with the first domain;
receiving, at the control server, a second message from a second domain, the second message being transmitted from a second domain device in the second domain and associated with the second user;
validating, at the control server, the second message by matching one or more elements of the first message to the second message;
causing transmission of a confirmation message to the second domain device in the second domain, the causing of the transmission of the confirmation message being based on the validating of the second message; and
causing transmission of the value from the control server in the first domain to an intermediary server in the second domain.

2. The method of claim 1, wherein the validating of the second message comprises:
in response to the first message, generating, by the control server, a confirmation code;
transmitting, by the control server in the first domain, the confirmation code to the first device;
receiving, at the control server, the confirmation code included within the second message; and
matching the first message to the second message based on the receiving of the confirmation code within the second message.

3. The method of claim 1, wherein the validating of the second message comprises:
receiving, at the control server from the second domain, the second user identification included within the second message; and
matching the first message to the second message based on the receiving of the second user identification within the second message.

4. The method of claim 1 further comprising:
registering the first user with the control server and the first domain.

5. The method of claim 1 further comprising:
registering the second user with the control server and the first domain; and
generating a identification token associated with the second user for the second domain, the identification token being configured to cause the second domain device to generate the second message.

6. The method of claim 5, wherein the second message includes the identification token, and the method further comprises:
in response to the first message, generating, by the control server, a confirmation code;
transmitting, by the control server in the first domain, the confirmation code to the first device;
receiving, at the control server from the second domain, the confirmation code included within the second message; and
matching the first message to the second message based on determining, by the control server, that the second message includes the identification token and the confirmation code.

7. The method of claim 5, wherein the second message includes the identification token and the value, and the validating of the second message comprises:
matching the first message to the second message based on determining, by the control server, that the second message includes the identification token and the value.

8. A method comprising:
receiving, at a control server in a first domain, a first domain message from a first device, the first domain message comprising: a value associated with a first user, a first user identification of the first user associated with the first domain, and a second user identification of a second user associated with the first domain;
receiving, at the control server, a second message from a communication domain separate from the first domain, the second message being transmitted from a communications device via a communications network;
validating, at the control server, the second message by matching one or more elements of the first message to the second message;
causing transmission of a confirmation message via the communications network; and
based on validation of the second message, causing transfer of the value from a first account associated with the first device to a second account associated with the second user, within the first domain.

9. The method of claim 8 further comprising:
in response to the first message, generating, by the control server, a confirmation code;
transmitting, by the control server, the confirmation code to the first device; wherein
the second message comprises an audio message that includes the confirmation code; and method further comprises matching the first message to the second message based on receiving the confirmation code within the second message.

10. A system comprising:
one or more processors; and
a non-transitory processor-readable storage medium storing processor executable instructions that, when executed by the one or more processors, cause the one or more processors to perform operations comprising:
receiving, at a control server in a first domain, a first message from a first device, the first message comprising: a value associated with a first user, a first user identification of the first user associated with the first domain, and a second user identification of a second user associated with the first domain;
receiving, at the control server, a second message from a second domain, the second message being transmitted from a second domain device in the second domain and associated with the second user;
validating, at the control server, the second message by matching one or more elements of the first message to the second message;
causing transmission of a confirmation message to the second domain device in the second domain, the causing of the transmission being based on the validating of the second message; and
causing transmission of the value from the control server in the first domain to an intermediary server in the second domain.

11. The system of claim 10, wherein the validating of the second message comprises:
in response to the first message, generating, by the control server, a confirmation code;
transmitting, by the control server in the first domain, the confirmation code to the first device;
receiving, at the control server, the confirmation code included within the second message; and
matching the first message to the second message based on the receiving of the confirmation code within the second message.

12. The system of claim 10, wherein the validating of the second message comprises:
receiving, at the control server from the second domain, the second user identification included within the second message; and
matching the first message to the second message based on the receiving of the second user identification within the second message.

13. The system of claim 10, wherein the operations further comprise:
registering the first user with the control server and the first domain.

14. The system of claim 10, wherein the operations further comprise:
registering the second user with the control server and the first domain; and
generating a identification token associated with the second user for the second domain, the identification token being configured to cause the second domain device to generate the second message.

15. The system of claim 14, wherein the second message includes the identification token, and the operations further comprise:
in response to the first message, generating, by the control server, a confirmation code;
transmitting, by the control server in the first domain, the confirmation code to the first device;
receiving, at the control server from the second domain, the confirmation code included within the second message; and
matching the first message to the second message based on determining, by the control server, that the second message includes the identification token and the confirmation code.

16. The system of claim 14, wherein the second message includes the identification token and the value, and the validating of the second message comprises:
matching the first message to the second message based on determining, by the control server, that the second message includes the identification token and the value.

17. A non-transitory processor-readable storage medium storing processor executable instructions that, when executed by a processor, cause the processor to perform operations comprising:
receiving, at a control server in a first domain, a first message from a first device, the first message comprising: a value associated with a first user, a first user identification of the first user associated with the first domain, and a second user identification of a second user associated with the first domain;
receiving, at the control server, a second message from a second domain, the second message being transmitted from a second domain device in the second domain and associated with the second user;
validating, at the control server, the second message by matching one or more elements of the first message to the second message;
causing transmission of a confirmation message to the second domain device in the second domain, the causing of the transmission of the confirmation message being based on the validating of the second message; and
causing transmission of the value from the control server in the first domain to an intermediary server in the second domain.

18. The non-transitory processor-readable storage medium of claim 17, wherein the validating of the second message further comprises:
in response to the first message, generating, by the control server, a confirmation code;
transmitting, by the control server in the first domain, the confirmation code to the first device;
receiving, at the control server, the confirmation code included within the second message; and
matching the first message to the second message based on the receiving of the confirmation code within the second message.

19. The non-transitory processor-readable storage medium of claim 17, wherein the validating of the second message further comprises:
receiving, at the control server from the second domain, the second user identification included within the second message; and
matching the first message to the second message based on the receiving of the second user identification within the second message.

20. The non-transitory processor-readable storage medium of claim 17, wherein the operations further comprise:
registering the second user with the control server and the first domain;
generating a identification token associated with the second user for the second domain, the identification token being configured to cause the second domain device to generate the second message;
in response to the first message, generating, by the control server, a confirmation code;
transmitting, by the control server in the first domain, the confirmation code to the first device;
receiving, at the control server from the second domain, the confirmation code and the identification token included within the second message; and
matching the first message to the second message based on determining, by the control server, that the second message includes the identification token and the confirmation code.
